(19) United States
(12) Patent Application Publication
(10) Pub. No.: US 2026/0103114 A1
(43) Pub. Date: Apr. 16, 2026

(54) Battery Unit, Method and Apparatus for Operating the Battery Unit

(71) Applicant: Schaeffler Technologies AG & Co. KG, Herzogenaurach (DE)

(72) Inventor: Ayman Ayad, Regensburg (DE)

(73) Assignee: Schaeffler Technologies AG & Co. KG, Herzogenaurach (DE)

(21) Appl. No.: 19/115,343

(22) PCT Filed: Sep. 12, 2023
(86) PCT No.: PCT/EP2023/074977

§ 371 Date: Mar. 26, 2025

(30) Foreign Application Priority Data
Sep. 30, 2022 (DE) 10 2022 210 418.8

(51) Int. Cl. B60L 58/22; B60L 50/64; H01M 10/42; H01M 50/51

(52) U.S. Cl. CPC B60L 58/22; B60L 50/64; H01M 10/425; H01M 50/51; H01M 2010/4271; H01M 2220/20

(57) ABSTRACT

A battery unit includes at least one string of battery modules and a low-voltage switching unit connectable to multiple low-voltage loads. The battery modules are electrically connected in series. Each battery module includes a plurality of battery cells electrically connected in series. Each battery module includes a balancing circuit with an output port and multiple input terminals connectable to the battery cells of the respective battery module. The output ports of the balancing circuits are connected to the low-voltage switching unit. Each of the balancing circuits is configured to provide on its output port an output voltage with a predetermined voltage value and to extract energy from a selected battery cell or from selected battery cells which are connected to the balancing circuit and to provide the energy at least partly as power supply to at least one of the low voltage loads connected to the low-voltage switching unit.

### CROSS-REFERENCE TO RELATED APPLICATIONS

This application claims priority to PCT Application PCT/EP2023/074977, filed Sep. 12, 2023, which claims priority to German Patent Application No. DE 10 2022 210 418.8, filed Sep. 30, 2022. The disclosures of the above applications are incorporated herein by reference.

### FIELD OF THE INVENTION

The present disclosure relates to a battery unit. Furthermore, it relates to a method and an apparatus for operating the battery unit. In addition, the present disclosure relates to a battery system, an electrical vehicle, a computer program, and a computer readable medium.

### BACKGROUND OF THE INVENTION

A high voltage battery pack of a battery electric vehicle or a plug-in hybrid electric vehicle is typically built by grouping battery cells in parallel and/or in series to compose battery cell modules. These modules are then electrically connected in series to provide a required high voltage on a DC link of the battery pack.

In order, to increase a maximum usable total power of battery cell modules the battery cells of the modules may be balanced or symmetrized. Balancing techniques mainly may be categorized into two categories: passive and active balancing. Passive balancing is achieved by discharging individual battery cells by use of a resistor connected in parallel with the battery cell. Normally, passive balancing is very cheap but takes a long time. In active balancing, an active charge transfer takes place, in which charge is removed from selected individual battery cells with a higher state of charge and fed to selected individual battery cells with a lower state of charge. Active balancing is very efficient and fast but, because of the additional hardware, expensive to be implemented.

### SUMMARY OF THE INVENTION

It is an object of the present invention to provide a battery unit which is flexibly operated and efficiently balanced.

According to the present disclosure, the above-mentioned object is achieved by the features of the embodiments described.

According to a first aspect, the above-mentioned object is achieved by a battery unit including at least one string of battery modules, which are electrically connected in series, and a low-voltage switching unit connectable to multiple low-voltage loads. The battery unit may be for an-electric vehicle. Alternatively, the battery unit may also be configured to be used in airplanes, big storage systems or even in small systems, like portable devices.

Each battery module includes a plurality of battery cells electrically connected in series. According to this disclosure a battery cell may represent a pack of second battery cells which are connected in parallel.

Each battery module of a group of battery modules of the at least one string of battery modules includes a balancing circuit. In an embodiment, the group of battery modules includes multiple battery modules or all battery modules of the at least one string.

The respective balancing circuit includes an output port and multiple input terminals connectable to the battery cells of the respective battery module. The output ports of the balancing circuits are connected to the low voltage switching unit. The respective balancing circuit is configured to provide on its output port an output voltage with a predetermined voltage value and to extract energy from a selected battery cell or from selected battery cells which are connected to the balancing circuit. Furthermore, the balancing circuit is configured to provide the energy at least partly as power supply to at least one of the low-voltage loads which are connected to the low-voltage switching unit.

The entire energy of the battery cells are fully utilized for powering the low-voltage loads. In addition, the balancing between the battery cells is done during operation and no energy is wasted.

In an embodiment, the battery modules may be used for back-up power supply. In order to supply low voltage (LV) auxiliary components and charge a LV battery, for example a 12-volt battery, a direct current-to-direct current converter (DC/DC-converter), which is configured to convert high voltage (HV) to LV is used. The DC/DC-converter bucks the HV (for example 400 volt or 800 volt to 12 volt. However, if the DC/DC-converter gets defective, the 12-volt battery cannot be charged, and the auxiliary loads cannot be supplied. To solve these problems and to increase the redundancy, some vehicle manufactures require implementing two DC/DC-converters. However, this does not completely solve the problem. If the two DC/DC-converters get defective, also no charging of the LV battery is possible. Furthermore, the DC/DC-converter is connected to the whole HV battery pack. This means if, for any reason, the operation of the HV battery pack is interrupted due to internal defect, then the DC/DC-converter will not be able to charge the 12-volt battery or supply the auxiliary low-voltage loads.

The battery unit according the first aspect allows to operate the low-voltage loads without a separate low-voltage battery.

According to at least one embodiment of the first aspect, the respective balancing circuit includes a switch matrix and a DC/DC converter. The switch matrix includes multiple switches for selectively connecting and disconnecting the battery cells in the battery module to the DC/DC converter of the battery module to control the discharging of the battery cells in the battery module. The DC/DC converter is configured to extract the energy from the selected battery cell or from the selected battery cells of the battery module, which are connected to the DC/DC converter via the switch matrix, and to provide the energy at least partly as the power supply to the at least one of the low-voltage loads which are connected to the low-switching unit.

The DC/DC converters of the balancing circuits may be used to supply the auxiliary low-voltage loads without a need for a LV battery. At the same time, the DC/DC converters may be used to balance the battery cells of the HV battery. So, there is no need for a passive or active balancing circuit. The balancing circuits are configured to balance the cells and supply the low-voltage loads simultaneously.

According to at least one embodiment of the first aspect, the switch matrix of the respective balancing circuit includes multiple switches for connecting a first pole of each battery cell with a first input terminal of the DC/DC converter and for connecting a second pole of each battery cell with a second input terminal of the DC/DC converter. This allows to connect any desired group of battery cells to the input port of the DC/DC converter dependent on provided control signals for the switches.

According to at least one embodiment of the first aspect, the DC/DC converter of the respective balancing circuit is an isolated bi-directional DC/DC converter.

According to at least one embodiment of the first aspect, the DC/DC converter of the respective balancing circuit is configured to operate in buck mode and boost mode.

This structure and configuration of the battery modules allows to operate the battery modules in a very flexible manner. This flexibility may be used for voltage and/or state of charge balancing of the battery modules and for providing energy or power to different low-voltage loads.

According to a second and third aspect, the above-mentioned object is achieved by a method and an apparatus for operating a battery unit according to the first aspect. For at least one battery module of the group of battery modules one or multiple battery cells of the respective battery module are selected for discharging dependent on received measurement signals for the battery cells of this battery module, wherein the respective received measurement signal is representative for a state of charge of a battery cell and/or battery cell voltage and/or a state of health of a battery cell. At least one balancing control signal is generated provided for the balancing circuit causing the balancing circuit to provide the energy at least partly as power supply to at least one of the low-voltage loads which are connected to the low voltage switching unit.

According to at least one embodiment of the second and third aspect, the at least one balancing control signal includes a first control signal and a second control signal. The first control signal is generated and provided for the switch matrix, such that the switch matrix connects the selected battery cell/cells with the DC/DC converter in a pre-defined manner. The second control signal is generated and provided for the DC/DC converter, such that the DC/DC converter discharges the connected battery cell/cells with a pre-defined current and provides a pre-defined supply voltage on the output port of the balancing circuit.

According to a fourth aspect, the above-mentioned object is achieved by a battery system including a battery unit according to the first aspect and an apparatus according to the third aspect.

According to a fifth aspect, the above-mentioned object is achieved-by an electric vehicle including a battery system according to the fourth aspect.

According to this disclosure an electric vehicle is a vehicle which includes an electric drive. So, an electric vehicle according to this disclosure is a pure electric vehicle, sometimes also called battery electric vehicle (“BEV”), or a hybrid electric vehicle (“HEV”), or a plug-in hybrid electric vehicle (“PHEV”).

Embodiments of the first aspect are also valid for the second to fifth aspect.

According to a sixth aspect, the present disclosure relates to a computer program which, when executed by a processor of a battery management apparatus, causes the battery management apparatus to perform the method according to the second aspect or an embodiment of the second aspect.

The computer program may be implemented as computer readable instruction code in any suitable programming language such as JAVA, C++, etc. The computer program may be stored on a computer-readable storage medium (CD-Rom, DVD, Blu-ray disc, removable drive, volatile or non-volatile memory, built-in memory/processor, etc.). The instruction code may program a computer or other programmable device, such as a control unit for a battery of an electric vehicle, such that the desired functions are performed. Further, the computer program may be provided on a network, such as the Internet, from which it may be downloaded by a user or automatically, as needed.

According to a seventh aspect, the present disclosure relates to a computer readable medium including a computer program which, when the program is executed by a processor of a battery management apparatus, causes the battery management apparatus to perform the method according to the second aspect or an embodiment of the second aspect.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

It is to be understood that both the foregoing general description and the following detailed description are merely exemplary and are intended to provide an overview or framework to understand the nature and character of the invention. The accompanying drawings are included to provide a further understanding of the invention. The drawings illustrate one or more embodiments, and together with the description serve to explain principles and operation of the various embodiments.

The same elements in different figures of the drawings are denoted by the same reference signs.

The drawings are not necessarily drawn to scale but are configured to clearly illustrate the disclosure.

FIG. 1 shows an exemplary embodiment of a battery system for an electric vehicle,

FIG. 2 shows an exemplary embodiment of a battery module, and

FIG. 3 shows a flow-chart of a program for operating a battery unit.

### DETAILED DESCRIPTION OF THE PREFERRED EMBODIMENTS

The following description of the preferred embodiment(s) is merely exemplary in nature and is in no way intended to limit the invention, its application, or uses.

The present disclosure is described in greater detail hereinafter with reference to the accompanying drawings showing embodiments of the disclosure. The disclosure may, however, be embodied in many different forms and should not be construed as limited to the embodiments set forth herein. Rather, these embodiments are provided so that the disclosure fully conveys the scope of the disclosure to those skilled in the art. While features of the present disclosure may be discussed relative to certain embodiments and figures below, all embodiments of the present disclosure may include one or more of the features discussed herein. In other words, while one or more embodiments may be discussed as having certain features, one or more of such features may also be used in accordance with the various embodiments of the disclosure discussed herein. In similar fashion, while exemplary embodiments may be discussed below as device, system, or method embodiments it should be understood that such exemplary embodiments may be implemented in various devices, systems, and methods.

It is noted that when an element is described as “connected” or “coupled” to another element, the element may be directly connected or coupled to the other element or intermediate elements may be present. In contrast, when an element is described as “directly” “connected” or “coupled” to another element, no intermediate elements are present. Other expressions used to describe the relationship between elements shall be interpreted in a like manner (e.g., “between” versus “directly between,”“adjacent”versus “directly adjacent,”etc.).

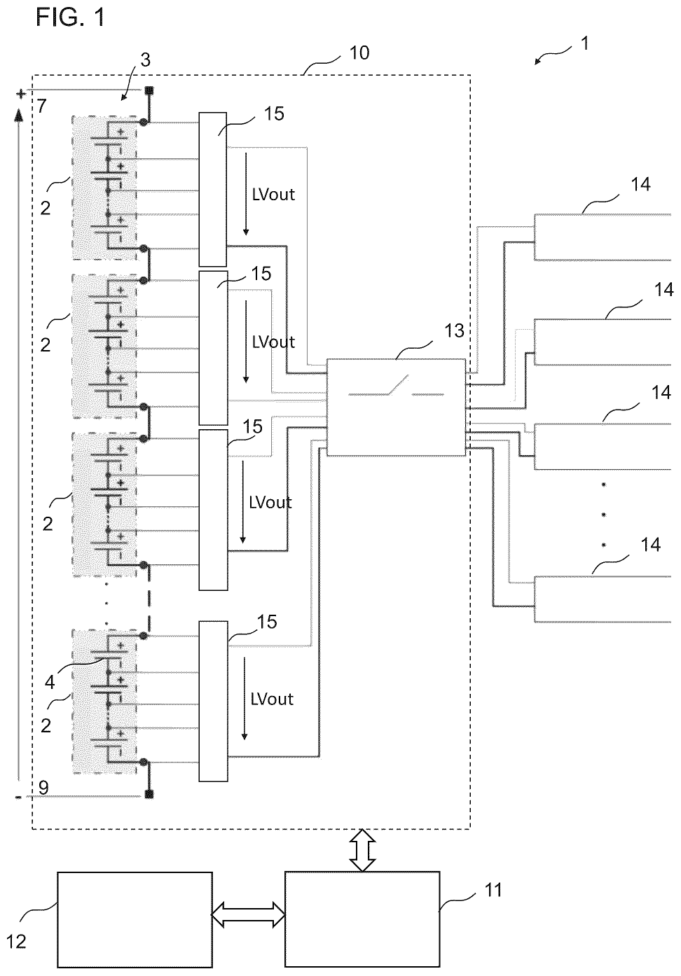

FIG. 1 shows an exemplary battery system 1, for instance, for an electric vehicle.

The battery system 1 includes a battery unit 10 and an apparatus 11 for operating the battery unit 10. The apparatus 11 for operating the battery unit 10 may also be named battery management system. The apparatus 11 for operating the battery unit 10 includes, for example, a battery management controller with a microprocessor or microcontroller. The apparatus 11 for operating the battery unit 10 may be configured to communicate with a vehicle control unit 12.

The battery unit 10 may also be named battery pack.

The battery unit 10 includes a plurality of battery modules 2. The battery modules 2 are electrically connected in series to form a string 3. In the embodiment shown in FIG. 1, the battery unit 10 includes only one string 3. Alternatively, the battery unit 10 may include more than one string 3 of battery modules 2. The string 3 of battery modules 2 provides a DC link voltage between main connectors 7, 9 of the battery unit 10. A nominal voltage of each battery module 2 is for example 48 volt.

The battery unit 10 includes a low-voltage switching unit 13 which is connected to multiple low-voltage loads 14.

The battery modules 2 include multiple battery cells 4, which are electrically connected in series to form a battery module 2. According to this disclosure a battery cell 4 may include a pack of second battery cells which are connected in parallel.

At least some of the battery modules 2 of the string 3 include a balancing circuit 15 for balancing its battery cells 4. Optionally, each battery module 2 of the string 3 includes such a balancing circuit 15. In this case the number of balancing circuits 15 is equal to the number of battery modules 2.

Each of the balancing circuits 15 includes an output port, which is connected to a low-voltage switching unit 13. Furthermore, each of the balancing circuits 15 includes multiple input terminals connected to the battery cells 4 of the respective battery module 2. Each of the balancing circuits 15 is configured to provide on its output port an output voltage LVout with a predetermined voltage value and to extract energy from a selected battery cell or from selected battery cells which are connected to the balancing circuit 15 and to provide the energy at least partly as power supply to at least one of the low-voltage loads 14 which are connected to the low-voltage switching unit 13.

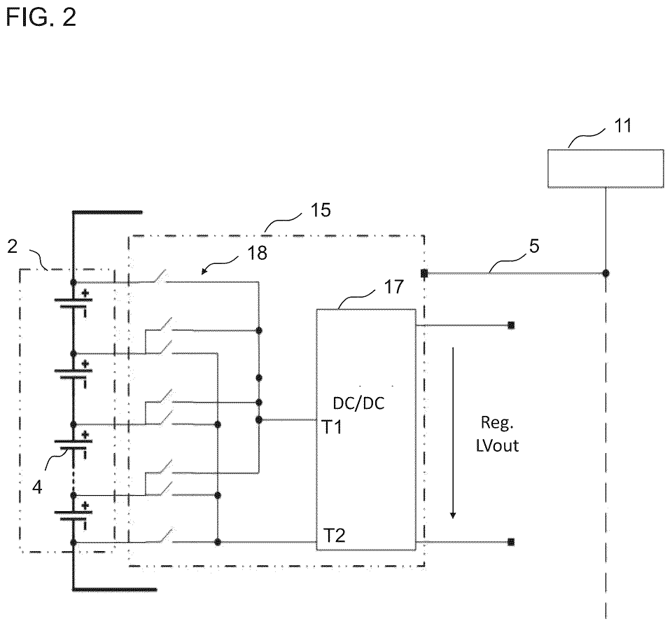

An exemplary embodiment of one of these balancing circuits 15 is shown in FIG. 2.

The balancing circuit 15 includes a switch matrix 18 and a DC/DC converter 17. The switch matrix 18 includes multiple switches for selectively connecting or disconnecting, respectively, the battery cells 4 in the battery module 2 to the DC/DC converter 17 to control discharging of the battery cells 4 in the battery module 2.

The switch matrix 18 includes multiple switches for connecting a first pole of each battery cell 4 with a first input terminal T1 of the DC/DC converter 17 and a second pole of each battery cell 4 with a second input terminal T2 of the DC/DC converter 17.

In an embodiment, the switch matrix 18 includes for each battery cell 4 a first switch for connecting the first pole of the respective battery cell 4 with the first input terminal T1 of the DC/DC converter 17 and a second switch for connecting the second pole of the respective battery cell 4 with a second input terminal T2 of the DC/DC converter 17.

The DC/DC converter 17 includes an output port which represents the output port of the balancing circuit 15 and which is connected to the low-voltage switching unit 13.

The DC/DC converter 17 is configured to extract energy from a selected battery cell or battery cells, which are coupled to the DC/DC converter 17 via the switch matrix 18, and to provide the energy at least partly as the power supply to the at least one of the low-voltage loads 14 which are connected to the low-voltage switching unit 13.

The switch matrix 18 is controlled to connect a battery cell/battery cells 4 that has/have higher state of charges (SoCs) to the DC/DC converter 17 and the DC/DC converter 17 boosts/bucks the voltage to, for example, 12 volt to provide the low-voltage power supply for one or more low-voltage loads 14.

The DC/DC converter 17 is, for example, an isolated bi-directional DC/DC converter.

The DC/DC converter 17 may be a multi-phase converter where each phase is connectable to one battery cell 4. This allows that any battery cell 4 or any group of battery cells 4 of the battery module 2 may be selected for discharging.

The balancing circuit 15 may include a battery cell supervision circuit. The battery cell supervision circuit may be configured to measure a voltage of each battery cell and two or three battery cell temperatures per battery module 2. These measurements may be sent to the apparatus 11 for operating the battery unit 10 to estimate the state of charge of each battery cell 4. For instance, the apparatus 11 for operating the battery unit 10 is configured to determine which battery cells 4 need to be discharged/balanced.

The battery module 2 includes, for example, a communication interface 5 to communicate with the apparatus 11 of the battery system 1 to transmit control instructions.

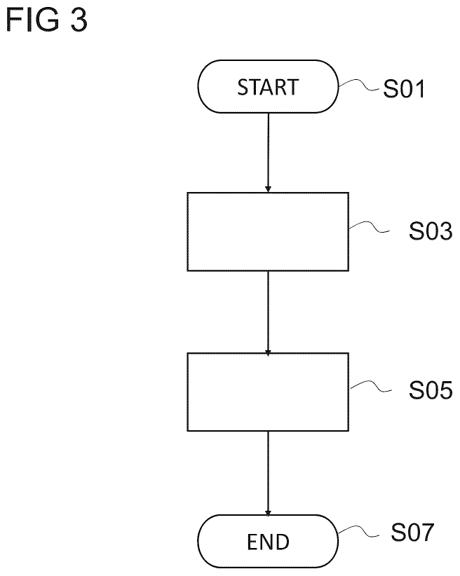

FIG. 3 shows an exemplary embodiment of a flow chart of a program for operating a battery unit 10 of an electric vehicle. The program steps may be performed for each battery module 2 of the group of battery modules 2 of the at least one string 3 of battery modules 2 which include a balancing circuit 15 configured to provide the supply voltage for the first DC/DC converter 17.

The program may run on a processor or controller of the apparatus 11 for operating the battery unit 10. The apparatus 11 for operating the battery unit 10 may include a distributed hardware and/or software architecture. Thus, the processor may be arranged in the electrical vehicle or outside of the vehicle.

In a step S01, the program is started. Furthermore, in step S01, for example, program variables are initialized.

In a step S03 for at least one battery module of the group of battery modules 4 one or multiple battery cells of the respective battery module 2 are selected for discharging dependent on received measurement signals for the battery cells 4 of this battery module 2.

In a step S05 at least one balancing control signal is generated and provided for the balancing circuit 15 causing the balancing circuit 15 to provide the energy at least partly as power supply to at least one of the low-voltage loads 14 which are connected to the low-voltage switching unit 13. The at least one balancing control signal may include a first control signal and a second control signal. The first control signal is generated and provided for the switch matrix 18, such that the switch matrix 18 connects the selected battery cell/cells with the DC/DC converter 17 in a pre-defined manner. The second control signal is generated and provided for the DC/DC converter 17, such that the DC/DC converter 17 discharges the selected battery cell/cells with a pre-defined current and provides a pre-defined supply voltage on the output port of the balancing circuit 15

Steps S03 and S05 may be repeated until the vehicle is parked. The program ends in a step S07. During operation of the vehicle and the balancing circuit 15, respectively, the low-voltage loads 14 connected to the low-voltage switching unit 13 may vary, for example an air-conditioning system of the vehicle may be turned on and off.

The description of the invention is merely exemplary in nature and, thus, variations that do not depart from the gist of the invention are intended to be within the scope of the invention. Such variations are not to be regarded as a departure from the spirit and scope of the invention.

### REFERENCE SIGNS

1 battery system
2 battery module
3 string of battery modules
4 battery cell
5 communication interface
7,9 main connector
10 battery unit
11 apparatus for operating a battery unit
12 vehicle control unit
13 low-voltage switching unit
14 low-voltage load
15 balancing circuit
17 DC/DC converter
18 switch matrix
S01, . . . , program steps
S07
T1, T2 input terminals of the second DC/DC converter

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A battery unit, comprising:
at least one string of battery modules electrically connected in series, each of the battery modules further comprising:
a plurality of battery cells electrically connected in series;
a balancing circuit having an output port and multiple input terminals connectable to the plurality of battery cells of the respective battery module;
a low-voltage switching unit connectable to multiple low-voltage loads, and each output port is connected to the low-voltage switching unit;
wherein each balancing circuit is configured to provide on its output port an output voltage with a predetermined voltage value and to extract energy from one or more of the plurality of battery cells which are connected to the balancing circuit and to provide the energy at least partly as power supply to at least one of the low voltage loads which are connected to the low voltage switching unit.

14. The battery unit of claim 13, each balancing circuit further comprising:
a DC/DC converter; and
a switch matrix, each of the plurality of battery cells are coupled to the DC/DC converter via the switch matrix, the switch matrix further comprising:
multiple switches for the selectively connecting and disconnecting one or more of the plurality of battery cells to the DC/DC converter;
wherein the DC/DC converter is configured to extract the energy from one or more of the plurality of battery cells, and to provide the energy at least partly as the power supply to at least one of the multiple low voltage loads.

15. The battery unit of claim 14, the switch matrix further comprising multiple switches for connecting a first pole of each battery cell with a first input terminal of the DC/DC converter, and for connecting a second pole of each battery cell with a second input terminal of the DC/DC converter.

16. The battery unit of claim 14, wherein the respective DC/DC converter is an isolated bi-directional DC/DC converter.

17. The battery unit of claim 14, wherein each DC/DC converter is configured to operate in buck mode and boost mode.

18. A method for operating a battery unit of claim 13, comprising the steps of:
selecting one or more of the plurality of battery cells of one of the battery modules for discharging dependent on received measurement signals for the one or more of the plurality of battery cells of the respective battery module;
generating at least one balancing control signal for the corresponding balancing circuit causing the corresponding balancing circuit to provide the energy at least partly as power supply to at least one of the low-voltage loads which are connected to the low-voltage switching unit.

19. The method of claim 18, further comprising the steps of:
providing a first control signal generated by the balancing circuit;
providing a second control signal generated by the balancing circuit;
generating the first control signal for the switch matrix, such that the switch matrix connects the selected of the plurality of battery cells with the DC/DC converter in a pre-defined manner; and
generating the second control signal for the DC/DC converter, such that the DC/DC converter discharges the selected of the plurality of battery cells with a pre-defined current and provides a pre-defined supply voltage on the output port of the balancing circuit.

20. The method of claim 18, further comprising the steps of:
providing a computer program; and
providing a battery management apparatus having a processor;
executing the computer program by the processor of the battery management apparatus to cause the battery management apparatus to perform the steps of the method of claim 18.

21. The method of claim 20, further comprising the step of providing a computer readable medium having the computer program.

22. A battery system comprising:
a battery unit, further comprising:
at least one string of battery modules electrically connected in series, each of the battery modules further comprising:
a plurality of battery cells electrically connected in series;
a balancing circuit having an output port and multiple input terminals connectable to the plurality of battery cells of the respective battery module;
a low-voltage switching unit connectable to multiple low-voltage loads, and each output port is connected to the low-voltage switching unit;
an apparatus for operating the battery unit;
wherein each balancing circuit is configured to provide on its output port an output voltage with a predetermined voltage value and to extract energy from one or more of the plurality of battery cells which are connected to the balancing circuit and to provide the energy at least partly as power supply to at least one of the low voltage loads which are connected to the low voltage switching unit.

23. The battery system of claim 22, wherein the battery system is part of an electric vehicle.
